(19) United States
(12) Patent Application Publication
(10) Pub. No.: US 2002/0069153 A1
(43) Pub. Date: Jun. 6, 2002

(54) E-commerce auto-valuation system

(76) Inventor: Mao-Yu Lin, Taipei (TW)

Correspondence Address: BIRCH STEWART KOLASCH & BIRCH, PO BOX 747, FALLS CHURCH, VA, 22040-0747, US

(21) Appl. No.: 09/796,479

(22) Filed: Mar. 2, 2001

(30) Foreign Application Priority Data
Dec. 6, 2000 (TW) 89125972

(51) Int. Cl. G06F 17/60

(52) U.S. Cl. 705/37; 705/27; 705/40

(57) ABSTRACT

The invention relates to an auto-valuation system for e-commerce, which makes both buyers and sellers able to evaluate the trading price according to the flexible prices provided. The auto-valuation system for e-commerce includes: a trade control module for providing the catalogs and controlling trading processes; an order accumulation module for respectively accumulating an order amount for all products from the trade control module; and a flexible pricing module for flexibly adjusting the pricing according to the accumulated order amount.

### BACKGROUND OF THE INVENTION

1. Field of the Invention

This invention relates to an auto-valuation system for e-commerce, which allows either the buyer or the seller able to partially evaluate the trading prices according to the flexible price provided.

2. Description of the Related Art

E-commerce has been one of the most rapidly developing fields in recent times. Starting from Amazon Bookstore on the Internet, web sites for e-commerce have been experiencing sudden growth. However, the prices offered depend on the seller, a consumer can do nothing to change the price of the product offered by the seller. Although some auction web sites can offer bids for articles on the Internet, the articles are limited by either amounts or types to be offered. Besides, auctions waste time, so that the goals of using those web sites, for example saving time and obtaining convenience for buying products, cannot be reached.

### SUMMARY OF THE INVENTION

Therefore, an object of the invention is to provide an e-commerce system, which provides the pricing system acceptable to both buyers and sellers.

Another object of the invention is to provide an auto-valuation system for e-commerce, which makes both buyers and sellers able to partially evaluate the trading price according to the flexible prices provided.

To realize the above and other objects, the invention provides an auto-valuation system for e-commerce, which makes both buyers and sellers able to partially evaluate the trading price according to the flexible prices provided. The auto-valuation system for e-commerce includes: a trade control module for providing catalogs and controlling trading processes; an order accumulation module for respectively accumulating order amounts of all products from the trade control module; and a flexible pricing module for flexibly adjusting the pricing according to the accumulated order amount. Also, an auto-valuation method for e-commerce, by using the auto-valuation system for e-commerce, is provided. The method includes the steps: displaying a catalog of brands and product types on the Homepage to be chosen; displaying all content including the promotions of every product according to the choice in order to determine an order; displaying the payment and delivery types to be chosen according to the order; and printing an invoice according to the order, the payment type, and the delivery type chosen in order to deal with the trade by the correlatives.

### BRIEF DESCRIPTION OF THE DRAWINGS

The invention will become apparent by referring to the following detailed description of a preferred embodiment with reference to the accompanying drawings, wherein:

FIG. 1 is a schematic diagram of an auto-valuation system for e-commerce;

FIG. 2 is a trade operation flowchart of FIG. 1;

FIG. 3 is an offer table of the products according to the invention;

FIG. 4 is an embodiment of a flexible relationship between product pricing and order accumulation according to the invention; and

FIG. 5 is another embodiment of a flexible relationship between product pricing and order accumulation according to the invention.

### DETAILED DESCRIPTION OF THE INVENTION

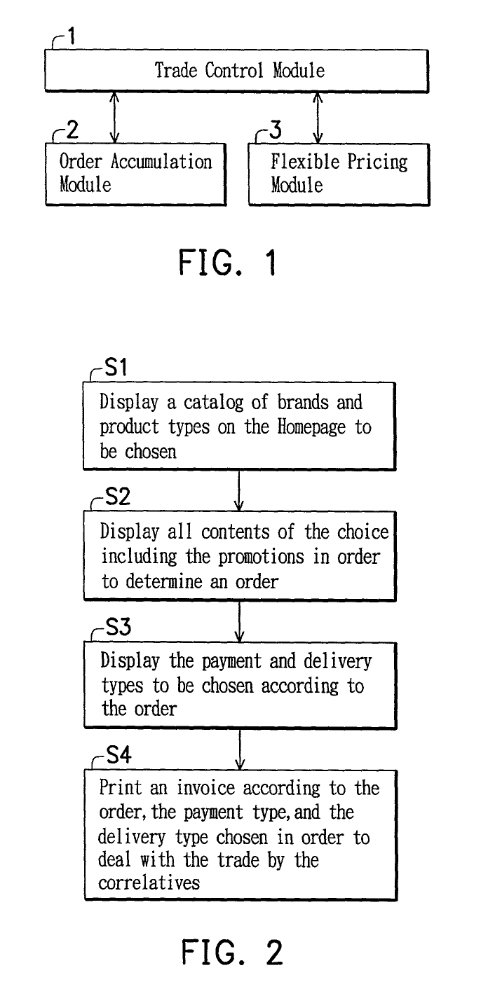

Refer to FIG. 1, a schematic diagram of an auto-valuation system for e-commerce. In FIG. 1, the auto-valuation system for e-commerce comprises: a trade control module, an order accumulation module, and a flexible pricing module. As shown in FIG. 1, a trade control module provides the catalogs and also controls the trading processes. For the trade able to be processed easily and smoothly, the calculation portion and the integration portion are not included into this module. Instead, an order accumulation module and a flexible pricing module respectively shoulder the duties of the calculation and the integration. The operating flowchart is described in detail as follows.

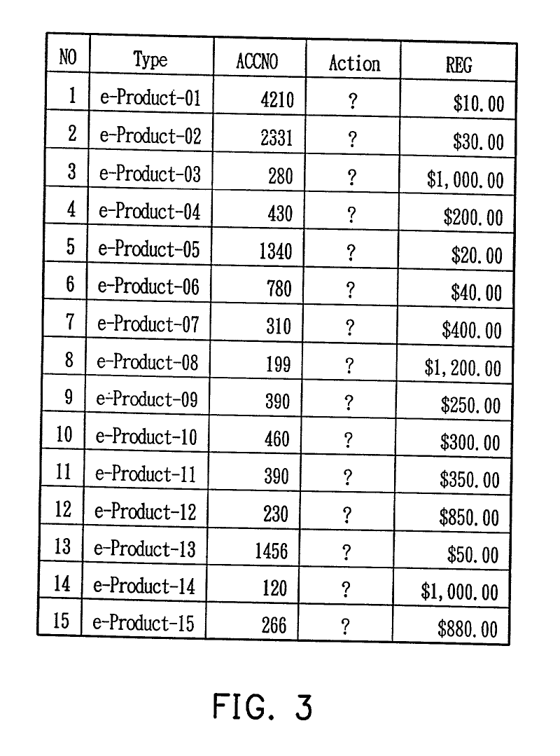

Refer to FIG. 2, the operation flowchart of the invention. As shown in FIG. 2, as soon as a consumer enters the web site, a catalog is on the Homepage by the trade control module 1 such that the consumer can click on an entry from a brand button or a product type button (S1). The trade control module 1 displays the content according to the clicked entrance (S2). For example, for the brand entry, all products and the respective promotions of every product under this brand are shown on the display (not shown). Thus, the consumer can determine an order including the product types and the amounts. The information of the products and the respective promotions of every product come from the order accumulation module 2 and the flexible pricing module 3. The order accumulation module 2 sums the real orders or the imaged orders. The flexible pricing module 3 establishes the relationship between the accumulation result of the order accumulation module 2 and the pricing offered by the trade control module 1 with respect to the accumulation result. The established relationship is displayed by the trade control module 1 in a table form (as FIG. 3, 4, and 5, shown later).

The real orders indicate that the consumer determines the order of the products according to the currently displayed pricing after summing up the determined order. The trade pricing of the determined order is different from before and after pricing changed with the accumulation amount. That is, the consumer has different pricing concerns for each order at different times. In this situation, the determined order is the real order. The imaged orders indicate that the consumer first determines the desired order of the products. Then, the trade pricing of the desired order is determined as the final pricing is determined at the time that the promotion is over. That is, all consumers have the same pricing for the desired product to be ordered on the same promotion cycle. Finally, a notice is sent to the consumer to confirm the desired order by the determined trade pricing. In this situation, the desired order is the imaged order when the consumer confirms the desired order.

Once the order is determined, the trade control module 1 provides the types of payment and delivery to the consumer for the choice (S3). For example, the consumer has the choice of payment type: checking, drafting, transferring, credit card, ATM card and so on and in the delivery types of express mail, ordinary mail, registered mail, or the obtainment from any contracted store, and so on. The trade control module 1 print an invoice according to the order, the payment type, and the delivery type in order to deal with the trade by the correlative (S4). In general, the consumer receives the product first and pays the money later. Also, the consumer can return the product within a limited time, for example a week, after the product is received.

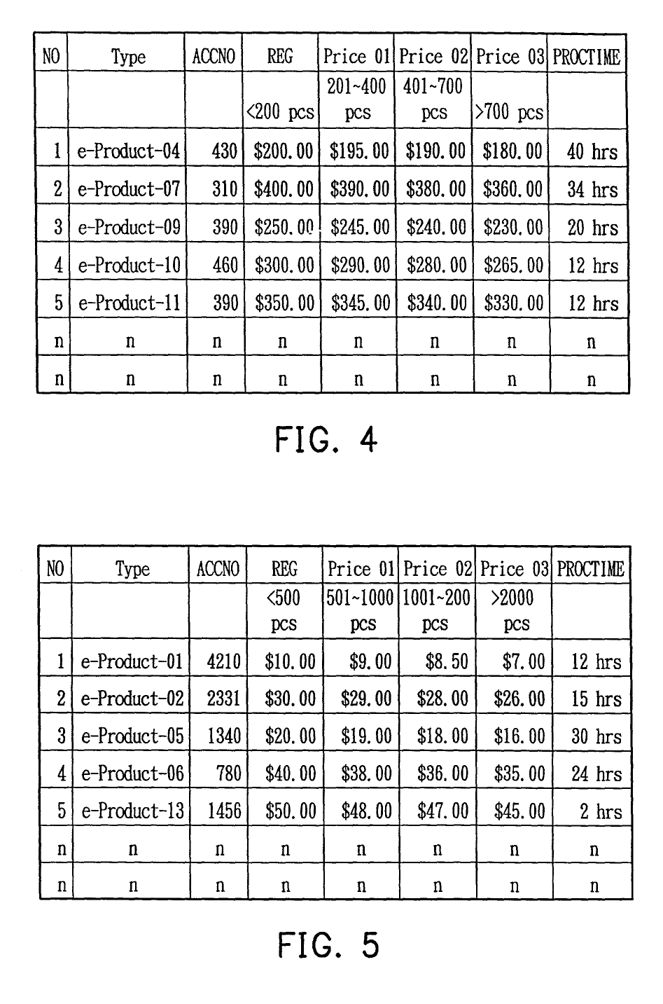

Refer to FIGS. 3, 4, and 5, for an example of a brand e, which provides two embodiments of the promotions. FIG. 4 is an embodiment of a 5-day cycle promotion. In FIG. 4, every 5 days, the order accumulation module 2 automatically recounts the order amount of each product and the trade control module 1 restarts the trade process. When an order is received, the trade control module 1 informs the correlative to deliver the products to the consumer according to the invoice printed by the trade control module 1. Similarly, FIG. 5 is an embodiment of a 10-day cycle promotion. That is, every 10 days, the order accumulation module 2 automatically recounts the order amount of each product and the trade control module 1 restarts the trade process. When an order is received, the trade control module 1 informs the correlative to deliver the product(s) to the consumer according to the invoice printed by the trade control module 1. The promotion cycle can be changed, for example to 3-day, 12-day, 20-days, or irregular promotion, by the supplies via the flexible-pricing module 3 according to requirements. As soon as a consumer enters the web site, the Homepage on the web site provides the choice frame for the brand and product types (not shown) by the trade control module 1. Assume that the consumer chooses the brand e, the trade control module 1 displays the content of the brand e as shown in FIG. 3, including product serial number NO, product name Type, accumulation order amount ACCNO from the order accumulation module 2, and pricing REG1 from the flexible pricing module 3, and promotion data Action. At this time, the consumer can find out the best choice by referring to FIGS. 4 and 5. Accordingly, an order is determined. FIGS. 4 and 5 include the serial number NO, product type Type, current accumulation ACCNO, the pricing with respect to the accumulation REG, Price 01, Price 02, and Price 03, and the residual time to the deadline PROCTIME. The trade control module 1 sends the amount of every product according to the order to the order accumulation module 2 to accumulate the total amount of every product. The accumulation result is sent to the flexible pricing module 3 through the trade control module 1 to be integrated with the pricing. Thus, a new relationship between the pricing and the accumulation is created into a table form similar to FIG. 4 and 5. The pricing of the new table (not shown) similar to FIG. 4 and 5 is the final trading price.

Additionally, the consumer can choose to deal with the trade in the imaged order form. As described above, the final trading price is unknown until the end of the a promotion cycle and the consumer receives a notice via the Internet to confirm the order when the final trading price is determined. That is, the consumer can further accept or cancel the order through the Internet. If the consumer confirms the order, the procedures followed are the same as the steps S3 and S4 as mentioned above. In such a way, the consumer in the same promotion cycle will have the same trading price, other than the foregoing real order, every consumer has a determined price that is respectively chosen by themselves.

To summarize the above, the promotion can be a periodic cycle or an irregular activity, wherein the cycle duration, the accumulation, and the pricing with respect to the accumulation can be rearranged at the beginning of every cycle. In other words, for any promotion on the web site of the invention, the consumer can see information on the serial number NO, product type Type, current accumulation ACCNO, the pricing with respect to the accumulation REG, Price 01, Price 02, and Price 03, and the residual time to the deadline PROCTIME (as shown in FIGS. 4 and 5). The discount pricing with respect to the accumulation of the order amount is automatically provided so as to solve the problems of wasted time, such as in an auction web site, and pricing inflexibility, as in a traditional web site. Thus, both the buyer and the seller are able to partially evaluate the trading prices according to the flexible price provided.

Although the invention has been described in its preferred embodiment, it is not intended to limit the invention to the precise embodiment disclosed herein. Those who are skilled in this technology can still make various alterations and modifications without departing from the scope and spirit of this invention. Therefore, the scope of the invention shall be defined and protected by the following claims and their equivalents.

What is claimed is:

1. An auto-valuation system for e-commerce, comprising:
a trade control module for providing the catalogs and controlling trading processes;
an order accumulation module for respectively accumulating order amounts of all products from the trade control module; and
a flexible pricing module for flexibly adjusting the pricing according to the accumulated order amount.

2. The auto-valuation system for e-commerce of claim 1, wherein the catalogs include a brand catalog and a product type catalog.

3. The auto-valuation system for e-commerce of claim 1, wherein the trade control module further controls the display of the relationship between the accumulated order amount and the pricing.

4. An e-commercial auto-valuation method by using the auto-valuation system for e-commerce, comprising the steps:
displaying a catalog of brands and product types on the Homepage to be chosen;
displaying all content including the promotions of every product according to the choice in order to determine an order;
displaying the payment and delivery types to be chosen according to the order; and
printing an invoice according to the order, the payment type, and the delivery type chosen in order to deal with the trade by the correlatives.

5. The auto-valuation method for e-commerce of claim 4, in the step of displaying all content including the promotions for every product, further comprising a regular pricing and a flexible pricing to be displayed.

6. The auto-valuation method for e-commerce of claim 5, wherein the flexible pricing is changed with an order accumulation.

7. The auto-valuation method for e-commerce of claim 6, wherein the order accumulation is the respectively accumulating amounts of all products of the order.

8. The auto-valuation method for e-commerce of claim 4, wherein the payment type comprises using checking, drafting, transferring, credit card, and ATM card.

9. The auto-valuation method for e-commerce of claim 4, wherein the delivery type comprises express mail, ordinary mail, registered mail, and the direct delivery or pick up from any contracted store.

10. An auto-valuation method for e-commerce by using the auto-valuation system for e-commerce, comprising the steps:
displaying a catalog of brands and product types on the Homepage to be chosen;
displaying all content including the promotions of every product according to the choice in order to determine an imaged order;
determining a final trading price for the imaged order according to the respectively accumulating result of every product of the imaged order in the end of a promotion cycle;
determining the imaged order as an order having the final trading price via the network;
displaying the payment and delivery types to be chosen according to the order having the final trading price; and
printing an invoice according to the order having the final trading price, the payment type, and the delivery type chosen in order to deal with the trade by the correlatives.

11. The auto-valuation method for e-commerce of claim 10, in the step of displaying all content including the promotions of every product, further comprising a regular pricing and a flexible pricing to be displayed.

12. The auto-valuation method for e-commerce of claim 11, wherein the flexible pricing is changed with an imaged order accumulation.

13. The auto-valuation method for e-commerce of claim 12, wherein the imaged order accumulation is the respectively accumulating amounts of all products.

14.The auto-valuation method for e-commerce of claim 4, wherein the payment type comprises checking, drafting, transferring, credit card, and ATM card.

15. The auto-valuation method for e-commerce of claim 4, wherein the delivery type comprises express mail, ordinary mail, registered mail, and the direct delivery or pick up from any contracted store.
